(19) United States
(12) Patent Application Publication
(10) Pub. No.: US 2015/0067695 A1
(43) Pub. Date: Mar. 5, 2015

(54) INFORMATION PROCESSING SYSTEM AND GRAPH PROCESSING METHOD

(71) Applicants: Masaki Hamamoto, Tokyo (JP); Junichi Miyakoshi, Tokyo (JP)

(72) Inventors: Masaki Hamamoto, Tokyo (JP); Junichi Miyakoshi, Tokyo (JP)

(73) Assignee: HITACHI, LTD., Tokyo (JP)

(21) Appl. No.: 14/382,190

(22) PCT Filed: Mar. 28, 2012
(86) PCT No.: PCT/JP2012/002132

§ 371 Date: Aug. 29, 2014

(51) Int. Cl. G06F 9/50

(52) U.S. Cl. CPC G06F 9/5016
USPC 718/104

(57) ABSTRACT

The present invention solves the aforementioned problem with a parallel computer system that performs a plurality of processes to each of which a memory space is allocated by arranging information of graph vertices in a first memory space allocated to a first process and arranging edge information of the graph vertices in a second memory space allocated to a second process.

### BACKGROUND OF THE INVENTION

1. Field of the Invention

The present invention relates to an information processing system that performs graph processing and a processing method thereof.

2. Description of the Related Art

With the development of communication technology such as the Internet and an increase in recording density accompanying storage technology improvements, the amounts of data handled by enterprises and individuals increase dramatically and in recent years, it is becoming increasingly important to analyze connections (also called networks) of such big data. Particularly connections of data arising in the natural world such as human relations frequently have graphs with characteristics called scale-free and it is becoming increasingly important to analyze large graphs with a scale-free characteristic (JP-2004-318884-A).

As conventional technology of high-speed graphical analysis, a technology to perform parallel processing by arranging each vertex of a graph including all edges going out from each vertex in a single process is disclosed in Douglas Gregor and Andrew Lumsdaine, “Lifting sequential graph algorithms for distributed-memory parallel computation”, “OOPSLA '05 Proceedings of the 20th annual ACM SIGPLAN conference on Object-oriented programming, systems, languages, and applications”, ACM New York, USA, 2005, p. 423-437. Also a multi-thread processing mode in which the memory access time is concealed by switching the vertex to be processed in each time of memory access under the assumption that the scale of processing per vertex is small in graph processing and the fact that if focused on processing of one vertex, most of the processing time is the memory access time is understood as a challenge is disclosed in Andrew Lumsdaine and three others, “Challenges in Parallel Graph Processing”, Parallel Processing Letters, March 2007, Vol. 17, No. 1, p. 5-20. In addition, programming of large parallel processing imposes a heavy load on the programmer (can also be expressed as the user of a parallel computer system) and thus, a programming model based on the bulk synchronous parallel (BSP) model is generally used to enable the programmer to easily write and execute program code of graphical analysis and, for example, a graphical analysis framework using the BSP model is disclosed in Grzegorz Malewicz and six others, “Pregel: a system for large-scale graph processing”, SIGMOD '10 Proceedings of the 2010 international conference on Management of data, ACM New York, (UAS), 2010, p. 135-146. The processing mode of the BSP model mainly includes three processes of an “input edge process”, a “vertex information update process”, and an “output edge process” and a “general synchronization process” that waits until the three processes are completed for all vertices and by repeating these processes, the shortest path problem by breadth first searching or the page rank problem can be solved.

### SUMMARY OF THE INVENTION

A graph with a scale-free characteristic is a graph in which the distribution of degree follows exponentiation and is formed of a large number of vertices with a small number of edges and a small number of vertices (called hub vertices) with a large number of edges (also expressed as a large degree). A graph with a scale-free characteristic is characterized in that while the average degree is small without depending on the scale of the graph, the degree of the hub vertex with the maximum degree in the graph increases with an increasing scale of the graph. The magnitude of the degree of the hub vertex with the maximum degree may reach a few % of the total number of vertices in the graph. If particularly the output edge process of the aforementioned BSP model is focused on, the amount of processing thereof is proportional to the degree of the vertex to be processed. Thus, if the parallel number of calculation nodes is increased to process a graph with a scale-free characteristic faster, the output edge processing time of one hub vertex may exceed the average output edge processing time in calculation node units, posing a problem of being unable to obtain a speedup effect by parallel processing due to the output edge processing time of the hub edge.

It is assumed in a graph with, for example, four trillion vertices that the average degree of the vertex is 27, there are hub vertices connecting to 5% of vertices in the entire graph, the processing time per edge in the output edge process is 20 ns, and all vertices are intended for the output edge process. When the processing object is solved by 10,000 parallel calculation nodes, while the expected average output edge processing time per calculation node is (four trillion)×(27)×(20 ns)/(10,000 nodes)≈216 s, the output edge processing time of the single hub vertex is (four trillion)×(5%)×(20 ns)=4000 s, which shows that the speedup effect of parallel processing reaches a limit. Under the above conditions, about 500 parallel calculation nodes are a parallel processing scalability limit of the system and even if the parallel number is further increased, the speedup of processing cannot be expected.

As described above, output edge processing loads of hub vertices increasingly cause a bottleneck in a vertex-level parallel processing mode according to conventional technology in graph processing with an increasing scale of scale-free characteristics, posing a problem of being unable to provide an information processing system having excellent parallel processing scalability.

The present invention solves the aforementioned problem with a parallel computer system that performs a plurality of processes to each of which a memory space is allocated by arranging information of graph vertices in a first memory space allocated to a first process and arranging edge information of the graph vertices in a second memory space allocated to a second process.

According to the present invention, excellent parallel processing scalability can be ensured.

### BRIEF DESCRIPTION OF THE DRAWINGS

FIG. 1A is a diagram showing an example of an input graph to be analyzed;

FIG. 1B is a diagram showing an example of a graph data arrangement according to the present invention;

FIG. 2 is a diagram showing a logical system configuration of a parallel computer system as an embodiment of the present invention;

FIG. 3A is a diagram showing an example of hub portion edge allocation destination information;

FIG. 3B is a diagram showing an example of worker process virtual vertex holding status information;

FIG. 4 is a diagram showing an example of the configuration of normal vertex information and hub vertex information and a management method thereof;

FIG. 5 is a diagram showing an example of the configuration of virtual vertex information and the management method thereof;

FIG. 6 is a diagram showing an example of holding hub vertex list information;

FIG. 7 is a diagram showing an example of a virtual vertex ID conversion table;

FIG. 8 is a diagram showing positioning of an input edge process, a vertex information update process, and an output edge process in a graphical analysis process;

FIG. 9 is a diagram showing an example of the configuration of input graph information and the management method thereof;

FIG. 10 is a diagram showing an example of a physical system configuration of the parallel computer system as the embodiment of the present invention;

FIG. 11 is a diagram showing an example of a general processing flow chart;

FIG. 12 is a diagram showing an example of an arrangement method of input data;

FIG. 13 is a diagram showing a configuration example of a global vertex ID;

FIG. 14 is a diagram showing an operation example when a normal vertex is read in an input data arrangement process;

FIG. 15 is a diagram showing an operation example when a hub vertex is read in the input data arrangement process;

FIG. 16 is a flow chart showing an operation example of a master process in the input data arrangement process;

FIG. 17A is a flow chart showing an operation example of a worker process in the input data arrangement process;

FIG. 17B is a flow chart showing an operation example of the worker process in the input data arrangement process;

FIG. 18 is a diagram showing an operation example when the normal vertex is processed in a graph calculation process;

FIG. 19 is a diagram showing an operation example when the hub vertex is processed in the graph calculation process;

FIG. 20 is a flow chart showing an operation example of the master process in the graph calculation process;

FIG. 21A is a flow chart showing an operation example of the worker process in the graph calculation process;

FIG. 21B is a flow chart showing an operation example of the worker process in the graph calculation process;

FIG. 22A is a diagram showing a first example of a packet structure of a partial edge processing request; and

FIG. 22B is a diagram showing a second example of the packet structure of the partial edge processing request.

### DESCRIPTION OF THE PREFERRED EMBODIMENTS

### First Embodiment

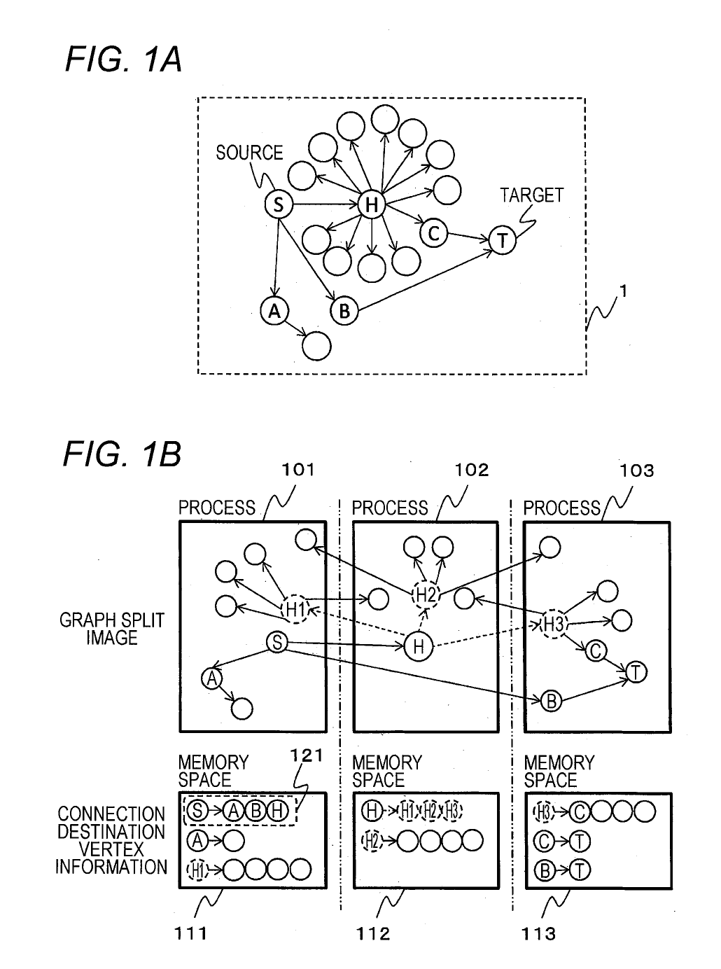

A graph processing method and an information processing system according to the present invention will be described using FIGS. 1A and 1B. FIG. 1A is a diagram showing an example of an input graph to be analyzed in the present invention. FIG. 1B is a diagram showing an example of an arrangement of the input graph in a plurality of processes.

In FIG. 1A, vertices are represented by a circle and directed edges are represented by an arrow connected to a vertex. If a vertex whose degree is five or more is defined as a hub vertex and a vertex whose degree is four or less is defined as a normal vertex, a vertex H of a graph 1 has five or more edges and so corresponds to a hub vertex. It is assumed here that the shortest path search based on breadth first searching is performed in which a vertex S is set as a source and a vertex T is set as a target. At this point, only the vertex S is active on a first search level and the vertex S transmits path information to three vertices of a vertex A, a vertex B, and a vertex H. On a second search level, the vertex A, the vertex B, and the vertex H are active and the vertex A transmits the path information to one vertex, the vertex B transmits the path information to one vertex, and the vertex H transmits the path information to 12 vertices. At this point, the output edge process of the vertex H needs 12 times the amount of processing when compared with the vertex A and the vertex B and the loads are non-uniform, causing deterioration of parallel processing scalability.

Thus, in an information processing system according to the present invention, like a graph division image in FIG. 1B, edges starting from the vertex H as a hub vertex are divided, divided edges are allocated to virtual vertices H1, H2, H3 that are virtual respectively, and further these virtual vertices are allocated to a process 101, a process 102, and a process 103 respectively. The process is an operating instance to which a memory space (can also be expressed as a storage area) is allocated by the operating system (OS) and is an execution unit of programs.

A processing load distribution state at this point will be described using connection destination vertex information in FIG. 1B. Connection destination vertex information of vertices held by the process 101 is stored in a memory space 111 and, for example, information 121 in which the vertex S is linked to the vertex A, the vertex B, and the vertex H is stored. The information 121 indicates that when the vertex S is active, it is necessary to perform the output edge process to the vertex A, the vertex B, and the vertex H. In FIG. 1B, the virtual vertex H1 as a virtual parent of connection destination vertices is arranged in the memory space 111 of the process 101, the virtual vertex H2 is arranged in a memory space 112 of the process 102, and the virtual vertex H3 is arranged in a memory space 113 of the process 103 in the connection destination vertex information respectively and so the output edge processing load of the vertex H is distributed.

Special processes described later are performed as processes on virtual vertices each indicated by a broken line and virtual edges to virtual vertices. That is, while the input edge process and the vertex information update process are performed on the vertex H in the process 102 in the same manner as on a normal vertex, a special process described later is performed as the output edge process on the virtual vertex H1, the virtual vertex H2, and the virtual vertex H3. Also, the input edge process and the vertex information update process on each of the virtual vertex H1, the virtual vertex H2, and the virtual vertex H3 are special processes described later.

Thanks to the technique described above, an information processing system according to the present invention can achieve excellent parallel processing scalability also in analysis processing of a graph having a scale-free characteristic. That is, the processing load of each process can be equalized by dividing a graph based on edges and allocating divided edges (hereinafter, called partial edges) to each process.

Hereinafter, a parallel computer system 10 will be described in detail as an example of an information processing system according to the present invention. In the description that follows, an example of the shortest path search is frequently shown as an example of processing of a graph to be processed by the information processing system according to the present invention, but to simplify the description, if not specifically mentioned, the shortest path search is assumed to use breadth first searching of a graph with no weights assigned to edges (can also be expressed as having a uniform edge weight).

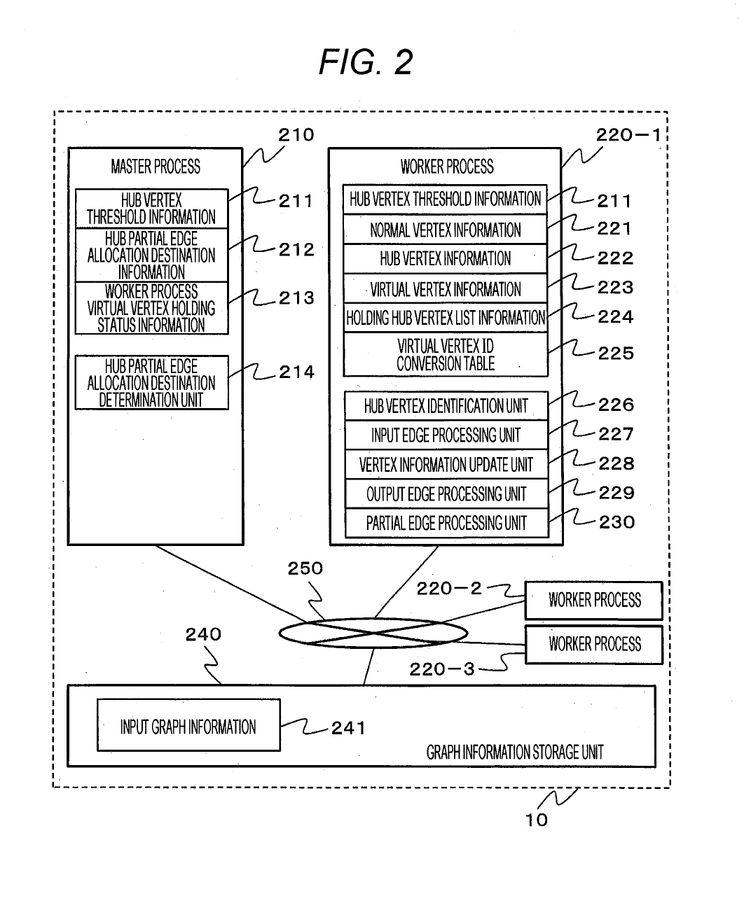

FIG. 2 is an example of a logical system configuration of the parallel computer system 10. The parallel computer system 10 includes a master process 210, one or more worker processes 220, a network 250, and a graph information storage unit 240. In FIG. 2, only three worker processes, a worker process 220-1, a worker process 220-2, and a worker process 220-3 are shown as the worker processes 220, but this is because of simplifying the description and the number of worker processes can be increased or decreased in accordance with the amount of graph processing or the like. Also in the description that follows, similarly a small number of worker processes are used to simplify the description. When a plurality of worker processes is handled as a group or there is no need to distinguish individual worker processes, such worker processes are represented as the worker processes 220. On the other hand, when worker processes are distinguished, such worker processes will be represented in an abbreviated form like a worker process 1 for the worker process 220-1, a worker process 2 for the worker process 220-2, and a worker process 3 for the worker process 220-3.

The master process 210 is a process that issues an initial data read instruction, processing start instruction and the like to the worker process 220 and includes hub vertex threshold information 211, hub partial edge allocation destination information 212, worker process virtual vertex holding status information 213, and a hub partial edge allocation destination determination unit 214 in a memory space provided to the master process 210. The hub vertex threshold information 211 is threshold information to determine whether a vertex is intended for edge division, that is, whether a vertex is a hub vertex in the present embodiment and is desirably information of the threshold of an amount proportional to the degree held by a vertex. Examples of the hub vertex threshold information 211 include information of the threshold of the degree held by a vertex and information of the magnitude of the amount of data of edge information. In the present embodiment, a case when information of the threshold of the degree held by a vertex is the hub vertex threshold information 211 is taken as an example.

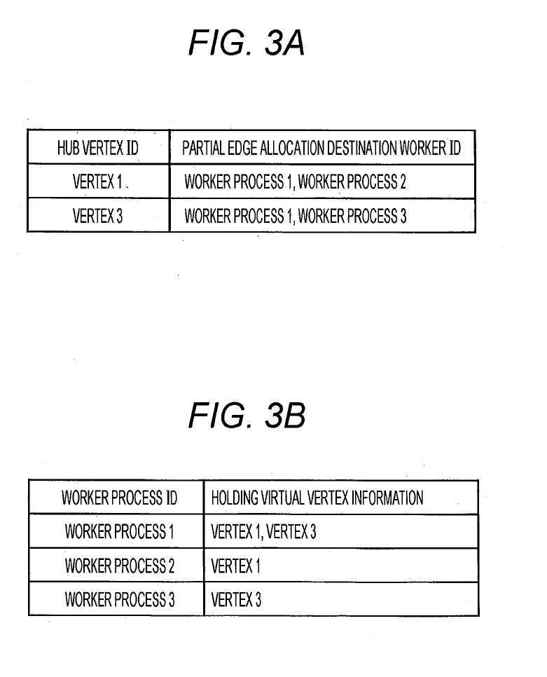

The hub partial edge allocation destination information 212 is information to manage the allocation destination of partial edges of a hub vertex to the worker process 220. FIG. 3A shows an example of the hub partial edge allocation destination information 212 in which the hub vertex and information about the worker process 220 to which partial edges thereof are allocated are shown in a tabular form. The example of FIG. 3A shows that a vertex 1 and a vertex 3 are hub vertices, partial edge information of the vertex 1 is allocated to the worker process 1 and the worker process 2, and partial edge information of the vertex 3 is allocated to the worker process 1 and the worker process 3.

The worker process virtual vertex holding status information 213 is information to manage virtual vertex information held by each process of the worker process 220. FIG. 3B shows an example of the worker process virtual vertex holding status information 213 in which worker process information (hereinafter, called the worker process ID) and vertex identification information (hereinafter, called the vertex ID) of a hub vertex are shown in a tabular form. The example of FIG. 3B shows that the worker process 1 holds information about virtual vertices of the vertex 1 and the vertex 3, the worker process 2 holds information about a virtual vertex of the vertex 1, and the worker process 3 holds information about a virtual vertex of the vertex 3. The worker process ID and the vertex ID can be set, as the worker process identification number and the vertex identification number respectively, as a serial number of the natural number beginning with 1. The hub partial edge allocation destination information 212 and the worker process virtual vertex holding status information 213 are the same in terms of the amount of information and an embodiment in which only one of the two pieces of information may also be adopted.

The hub partial edge allocation destination determination unit 214 is a unit that determines the allocation destination worker process of partial edges of a hub vertex from among the worker processes 220. As an embodiment, for example, the hub partial edge allocation destination determination unit 214 refers to the worker process virtual vertex holding status information 213 to preferentially allocate partial edges to, among the worker processes 220, the worker process holding the smallest number of virtual vertices.

The worker process 220 is a process that performs a graph calculation process and includes the hub vertex threshold information 211, normal vertex information 221, hub vertex information 222, virtual vertex information 223, holding hub vertex list information 224, a virtual vertex ID conversion table 225, a hub vertex identification unit 226, an input edge processing unit 227, a vertex information update unit 228, an output edge processing unit 229, and a partial edge processing unit 230 in a memory space provided to each of the worker processes 220. The hub vertex threshold information 211 is the same information as the hub vertex′threshold information 211 of the master process 210.

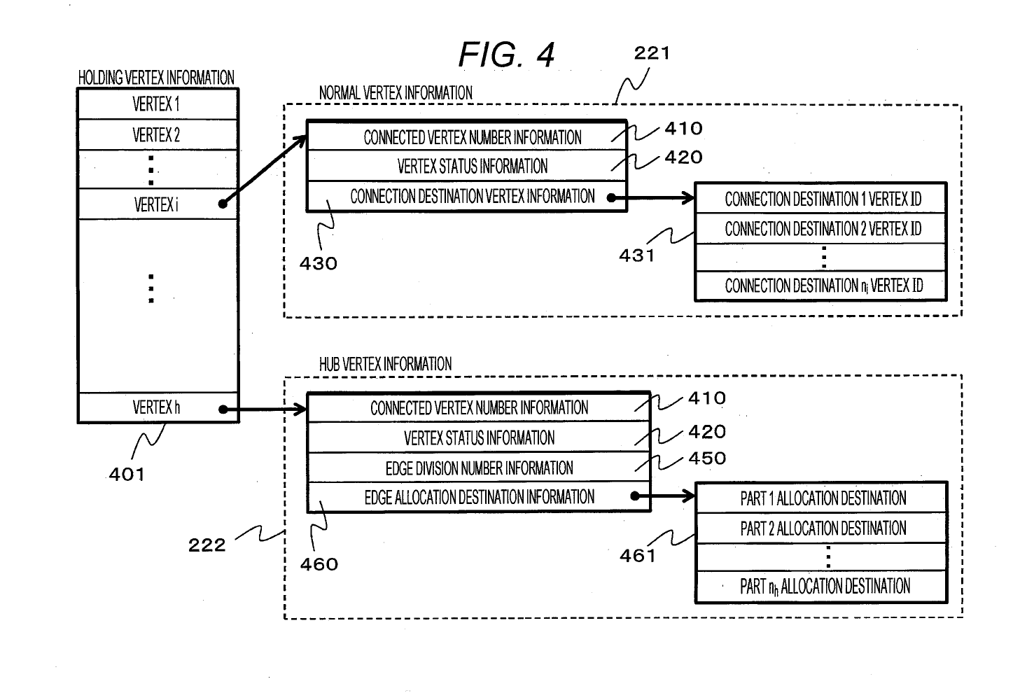

The normal vertex information 221 is vertex information about a vertex that is not a hub vertex (this will be called a normal vertex) in a graph to be analyzed and contains, as shown in FIG. 4, connected vertex number information 410, vertex status information 420, and connection destination vertex information 430. The connected vertex number information 410 is information of the number of edges starting from each vertex toward other vertices (hereinafter, called output edges), that is, the degree. The vertex status information 420 is information showing the status of a vertex in graphical analysis and in, for example, the shortest path problem in which a vertex T is to be reached from a vertex S as the starting point, shortest path information from the vertex S to some vertex and visited status information indicating whether the vertex is already visited correspond to the vertex status information. The connection destination vertex information 430 is information containing vertex IDs of vertices linked to from each vertex. If, for example, some vertex is linked to nᵢ vertices, the connection destination vertex information 430 contains nᵢ vertex IDs for the vertex. In FIG. 4, the connection destination vertex information 430 contains a connection destination vertex ID array 431 and an embodiment in which the first address of the connection destination vertex ID array 431 is pointed to is shown.

The hub vertex information 222 is vertex information about a hub vertex in a graph to be analyzed and contains, as shown in FIG. 4, the connected vertex number information 410, the vertex status information 420, edge division number information 450, and edge allocation destination information 460. The connected vertex number information 410 and the vertex status information 420 are the same as the information described in connection with the normal vertex information 221 and so the description thereof is omitted. The edge division number information 450 is information showing how many edge groups an output edge group held by a hub vertex is divided into and corresponds to information showing how many virtual vertices some hub vertex is linked to. The edge allocation destination information 460 contains worker process IDs to which output edges of each hub vertex are allocated and if output edges of some hub vertex are divided and allocated to the nₕ worker processes 220, contains nₕ worker process IDs for the hub vertex. In FIG. 4, the edge allocation destination information 460 contains a part allocation destination information array 461 and an embodiment in which the first address of the part allocation destination information array 461 is pointed to is shown. The edge allocation destination information 460 can also be regarded as information about virtual output edges toward virtual vertices indicated by a broken line in FIG. 1B.

The normal vertex information 221 and the hub vertex information 222 can be managed in various forms and, as an example, in a form in which vertex information held by the worker process 220 is managed by an array structure having, like holding vertex information 401, vertex IDs as elements, the first address of a structure of vertex information of a vertex j is stored in a j-th element, the first address of the normal vertex information 221 of a normal vertex i is stored for a vertex i as a normal vertex, and the first address of the hub vertex information 222 of a hub vertex h is stored for a vertex h as a hub vertex can be implemented.

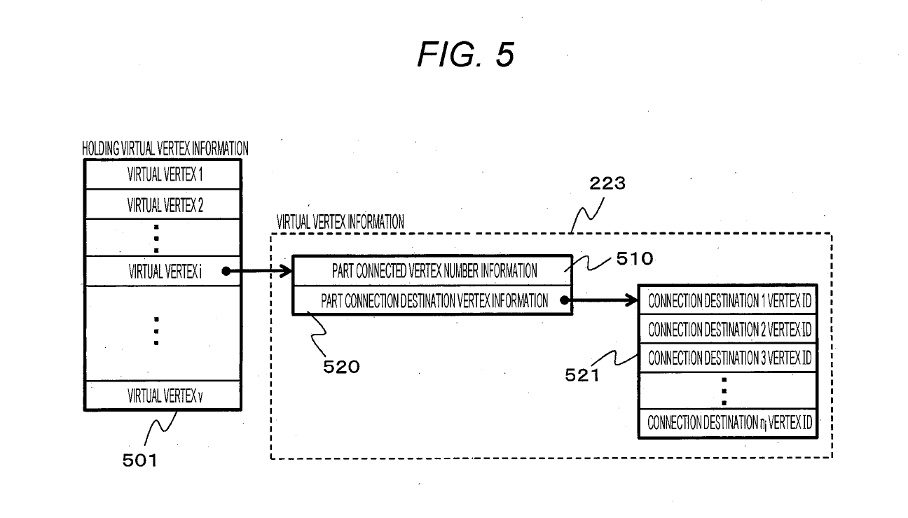

The virtual vertex information 223 is vertex information about a virtual vertex held by the worker process 220 and contains, as shown in FIG. 5, part connected vertex number information 510 and part connection destination vertex information 520. The part connected vertex number information 510 is information of the number of output edges of a virtual vertex. The part connection destination vertex information 520 is a vertex ID to which a virtual vertex is linked and if a virtual vertex is linked to nᵢ vertices, contains nᵢ vertex IDs. In FIG. 5, the part connection destination vertex information 520 contains a connection destination vertex ID array 521 and an embodiment in which the first address of the connection destination vertex ID array 521 is pointed to is shown.

The virtual vertex information 223 can be managed in various forms and, as an example, a form in which information about a virtual vertex held by the worker process 220 is managed by an array structure having, like holding virtual vertex information 501, virtual vertex IDs as elements and the first address of a structure of the virtual vertex information 223 of a virtual vertex i is stored in an i-th element can be implemented.

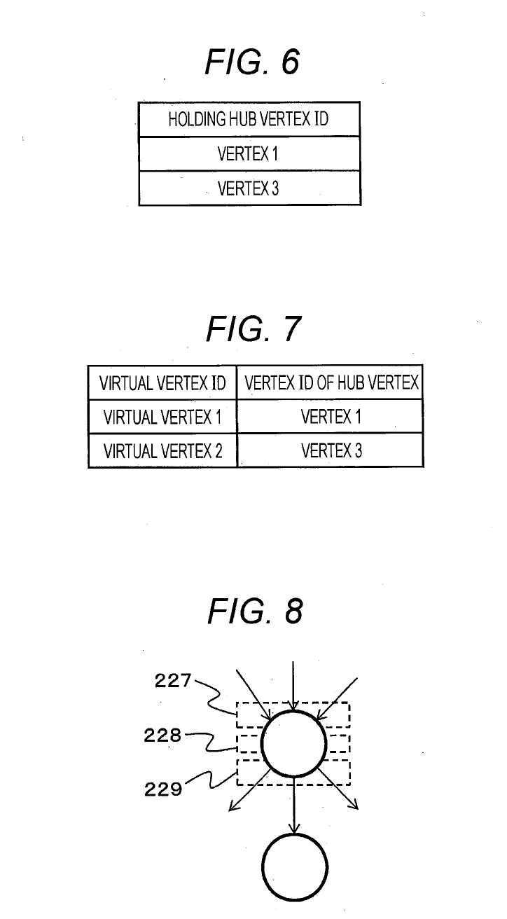

The holding hub vertex list information 224 is a vertex ID of a hub vertex held by the worker process 220 and contains, as shown in FIG. 6, hub vertex IDs held by each of the worker processes 220. FIG. 6 shows an example in which one of the worker processes 220 holds the vertex 1 and the vertex 3.

The virtual vertex ID conversion table 225 is a table that associates the vertex ID of a hub vertex to be a parent of partial edges allocated to the worker process 220 and the ID as a virtual vertex in the worker process 220 and is a table as shown in FIG. 7. For example, it is assumed that the vertex 1 and the vertex 3 are hub vertices, partial edges thereof are allocated to one of the worker processes 220, and the worker process manages virtual vertices like the holding virtual vertex information 501 in FIG. 5. In this case, while it is easy to manage array elements of the holding virtual vertex information 501 by setting consecutive values like in FIG. 5, it is difficult to manage vertex IDs of hub vertices by consecutive values because hub vertices are a portion of all vertices. If nonconsecutive values are used as array element numbers, utilization efficiency of the memory space will be very low. In contrast, utilization efficiency of the memory space can dramatically be increased by converting vertex IDs hub vertices into virtual vertex IDs that are consecutive values in the worker process 220 and easy to manage. Thus, the worker process 220 holds the virtual vertex ID conversion table 225 to increase the utilization efficiency of the memory space. FIG. 7 shows an example of the conversion table in which partial edges of the vertex 1 are set as output edges of a virtual vertex 1 and partial edges of the vertex 3 are set as output edges of a virtual vertex 2.

The hub vertex identification unit 226 is a unit to identify whether a vertex to be identified is a normal vertex or a hub vertex and basically makes an identification by comparing the holding hub vertex list information 224 and the vertex ID of the vertex to be identified, but when degree information is set as the hub vertex threshold information 211, an identification can also be made by comparing the connected vertex number information 410 and the hub vertex threshold information 211. The present embodiment will be described by assuming that an identification is made by referring to the holding hub vertex list information 224.

The input edge processing unit 227 is, as indicated by a plurality of arrows toward a vertex shown as a circle in FIG. 8, a unit that performs processing of information input from other vertices and performs, in an example of the shortest path search problem with no edge weights, processing such as bringing together access from a plurality of edges. In an example of the shortest path search problem with edge weights, processing such as calculating the minimum value of a path length corresponds to processing to be performed.

The vertex information update unit 228 is a unit to update the vertex status information 420 and performs, in an example of the shortest path search problem, processing such as update processing in which the vertex ID of a vertex to be processed by the input edge processing unit 227 is added to shortest path information received by the input edge processing unit 227 and update processing of visited status information of vertices to be processed by the input edge processing unit 227.

The output edge processing unit 229 is, as indicated by an arrow connecting vertices shown as circles in FIG. 8, a unit that performs information output processing to other vertices and performs, in an example of the shortest path search problem, processing such as transmitting shortest path information updated by the vertex information update unit 228 to all vertices of output edge destinations.

The partial edge processing unit 230 performs output edge processing on the virtual vertex information 223. The partial edge processing unit 230 basically performs the same processing as that of the output edge processing unit 229, but there are differences in that information on which data to be transmitted to vertices as output edge destinations is based is transmitted from the other worker processes 220.

The network 250 is an element that connects the master process 210, each process of the worker processes 220, and the graph information storage unit 240 and various communication protocols such as PCI Express or InfiniBand can be applied.

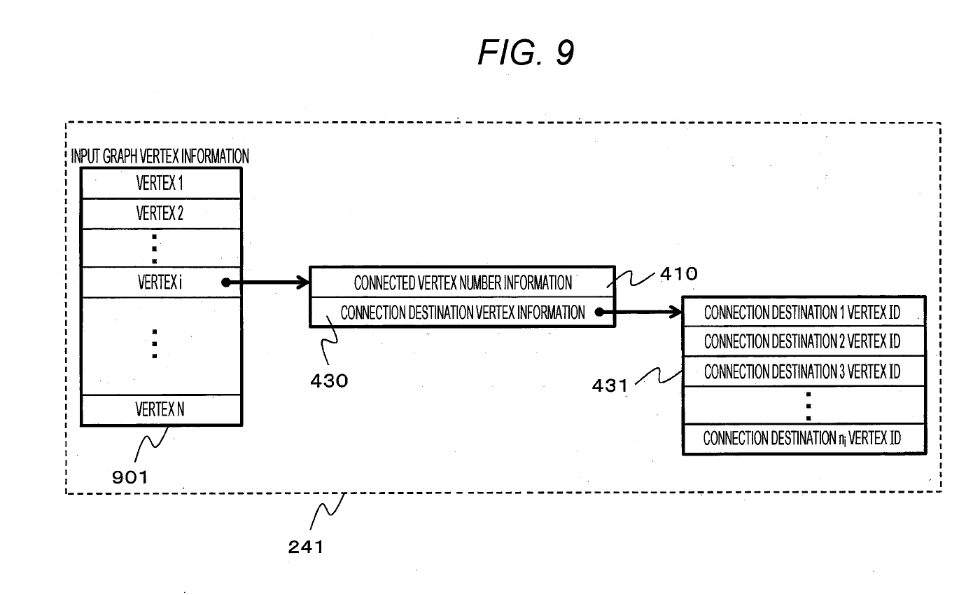

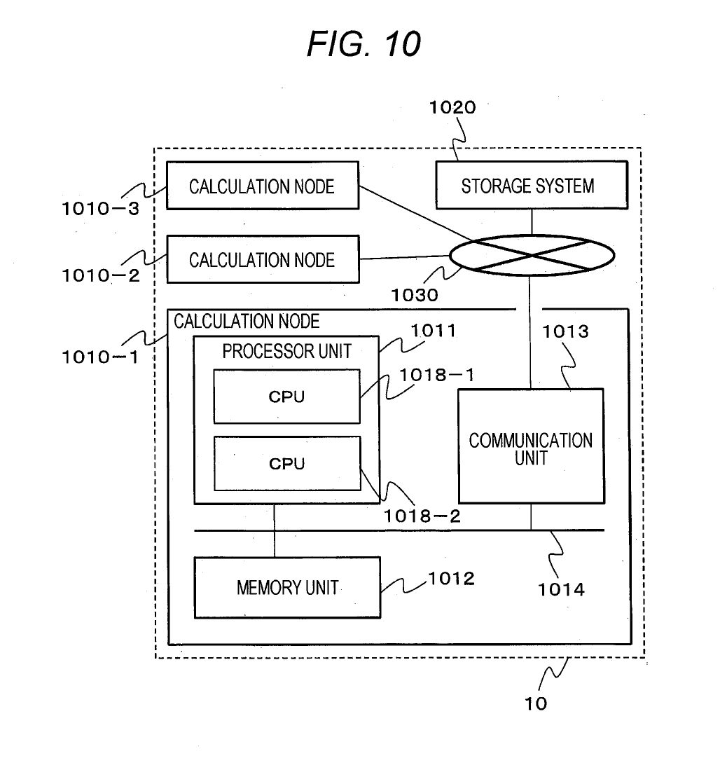

The graph information storage unit 240 is a storage space in which input graph information 241 to be analyzed is stored. FIG. 9 shows an example of the storage format of the input graph information 241. Here, an example of storing the input graph information 241 in a form in which vertices contained in a graph are managed by input graph vertex information 901 as an array having vertex IDs as elements and the connected vertex number information 410 and the connection destination vertex information 430 are allocated to each vertex as vertex information. The first address of a structure of vertex information of a vertex i is stored as an i-th element (vertex i) of the input graph vertex information 901. Edge weight information (not shown) corresponding to the connection destination vertex information 430 is added to a structure of vertex information when edges have weights, but to simplify the description of the present embodiment, only the connection destination vertex information 430 is handled as having no weighted edges.

Next, an example of the physical system configuration of the parallel computer system 10 will be described using FIG. 10. The parallel computer system 10 includes one or more calculation nodes 1010, a storage system 1020, and a network 1030. In FIG. 10, an example in which the parallel computer system 10 includes three calculation nodes, calculation nodes 1010-1, 1010-2, 1010-3 as the calculation node 1010 is shown.

The calculation node 1010 is a unit that executes program code written by a user and includes a processor unit 1011, a memory unit 1012, a communication unit 1013, and a bus 1014. The calculation node 1010 is, for example, a server device. The processor unit 1011 includes one or more central processing units (CPU) 1018. The parallel computer system 10 in FIG. 10 shows an example in which the processor unit 1011 includes a CPU 1018-1 and a CPU 1018-2. The master process 210 or the worker process 220 shown in FIG. 2 is allocated to each of the CPUs 1018.

The memory unit 1012 is a storage unit configured by a dynamic random access memory (DRAM) or the like. Each process allocated to the CPU 1018 has a specific memory area (also called a memory space) inside the memory unit 1012 allocated thereto. Inter-process communication is used to exchange data between processes.

The communication unit 1013 is a unit to communicate with the calculation node 1010 or the storage system 1020 via the network 1030 and performs processing to transmit information about a transmitting buffer in the memory space of each process to the calculation node 1010 having a destination process or processing to write information received from outside into a receiving buffer of the destination process. However, when the destination process is inside the local calculation node 1010, inter-process communication can be performed without going through the network 1030. The bus 1014 is a network inside the calculation node 1010 connecting the processor unit 1011, the memory unit 1012, and the communication unit 1013.

The storage system 1020 is a physical device corresponding to the graph information storage unit 240 in which the input graph information 241 in FIG. 2 is stored and may be inside or outside the parallel computer system 10. The network 1030 is a communication channel that connects the calculation nodes 1010 or the calculation node 1010 and the storage system 1020. The network 1030 includes routers, switches and the like as network devices. In the case of communication between processes arranged in different calculation nodes, the network 1030 is included in a portion of the physical configuration of the network 250 in FIG. 2.

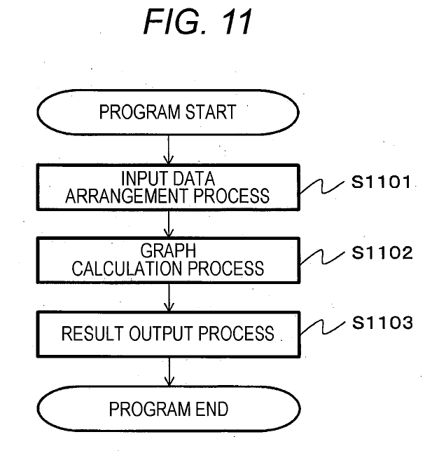

Next, an overall operation of a graphical analysis process performed by the parallel computer system 10 will be described using an overall processing flow chart in FIG. 11. As shown in FIG. 11, processing performed by the parallel computer system 10 includes three steps of an input data arrangement process S1101, a graph calculation process S1102, and a result output process S1103.

In the input data arrangement process S1101, the parallel computer system 10 reads the input graph information 241 from the graph information storage unit 240 and arranges the read information in each of the worker processes 220. In the present embodiment, the hub vertex threshold information 211 is used as the degree and thus, in step S1101, a vertex having a degree larger than a predetermined degree threshold is handled as a hub vertex and edge information (connection destination vertex information 430) held by a hub vertex is divided and arranged in the different worker processes 220.

The graph calculation process S1102 is a processing step that performs kernel processing of graphical analysis. In the graph calculation process S1102, the parallel computer system 10 performs input edge processing, vertex information update processing, and output edge processing for each vertex and further performs overall synchronization processing to obtain an analysis result by repeating the above processing.

The result output process S1103 is a processing step that outputs an analysis result. In the result output process S1103, the parallel computer system 10 outputs a result to a display apparatus or outputs a result as a file.

Hereinafter, the input data arrangement process S1101 and the graph calculation process S1102 according to the present embodiment will be described in detail.

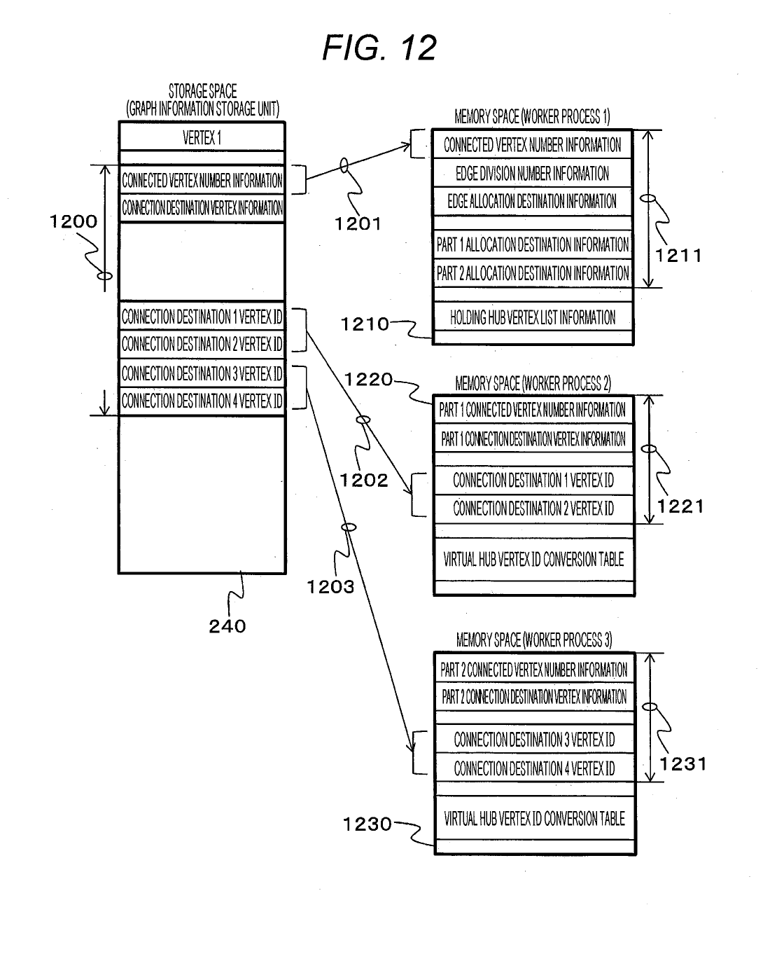

First, the input data arrangement process S1101 will be described. In the input data arrangement process S1101, the parallel computer system 10 performs processing that divides the input graph information 241 in a storage space of the graph information storage unit 240 and arranges the divided information in the worker processes 220. In the input data arrangement process S1101 according to the present embodiment, edge information of a vertex whose degree is larger than a predetermined value is divided and arranged, as shown in FIG. 12, in the different worker processes 220. In FIG. 12, an example in which the vertex 1 is a hub vertex, vertex information 1200 of the vertex 1 is divided, hub vertex information 1211 containing connected vertex number information 1201 is allocated to the worker process 1, connection destination vertex information 1202, 1203 is allocated to the worker process 2 and the worker process 3 respectively, and the worker process 2 and the worker process 3 hold virtual vertex information 1221, 1231 in a memory space based on the allocated connection destination vertex information respectively is shown.

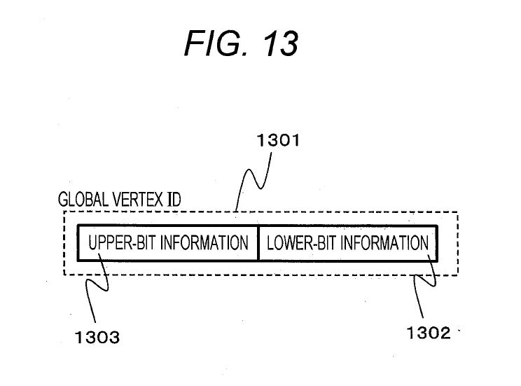

While the vertex ID of the vertex 1 of the graph information storage unit 240 needs to be the only vertex ID (global vertex ID) in the input graph information 241, the vertex ID of the vertex 1 in the worker process 220 only needs to the only vertex ID (local vertex ID) in the relevant worker process 220. However, the global vertex ID needs to be used to communicate with another worker process. Thus, in the present embodiment, as shown in FIG. 13, lower-bit information 1302 of a global vertex ID 1301 is set as a worker process ID of the worker process in which vertex information of the vertex is arranged and upper-bit information 1303 is set as a local vertex ID in the worker process 220 in which the vertex information of the vertex is arranged. In this manner, vertex IDs can be managed as consecutive values in the holding vertex information 401 more easily, the holding vertex information 401 can be stored in a smaller memory space, and further when each worker process communicates with another worker process, the global vertex ID can correctly be restored by adding the local worker process ID to lower bits, which makes the processing more efficient.

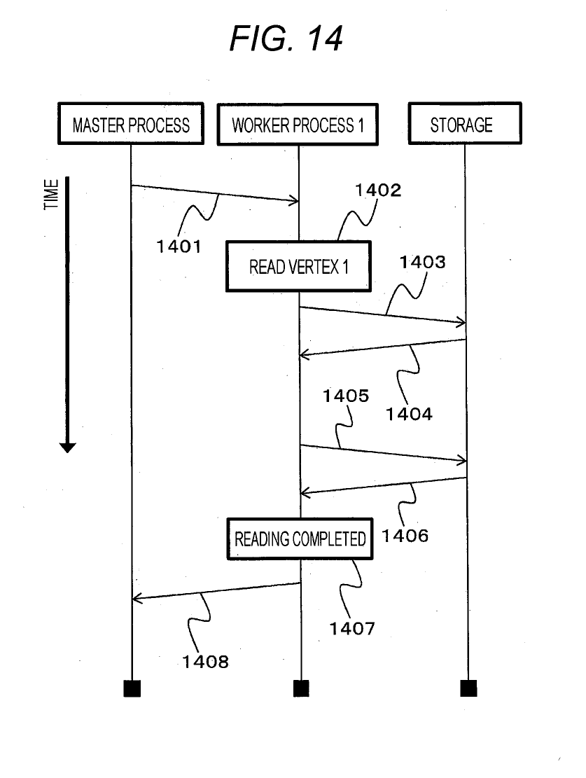

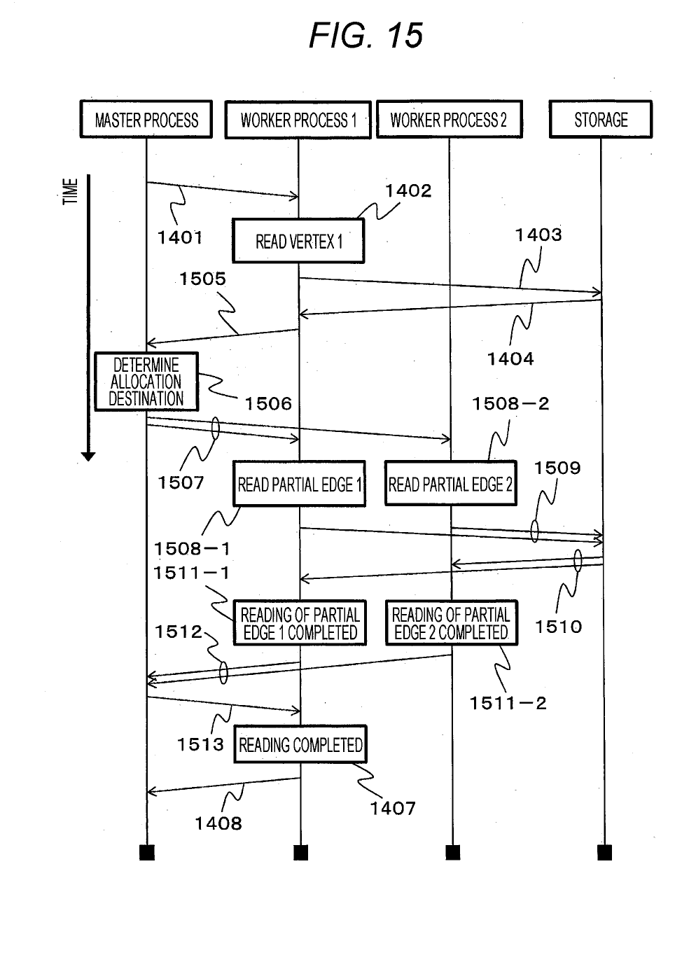

Hereinafter, an operation example of the master process 210 and the worker process 220 in the input data arrangement process S1101 will be described using FIGS. 14 and 15. To simplify the description, only two worker processes, the worker process 1 and the worker process 2 are used as the worker process 220 for the description that follows. The master process in FIGS. 14 and 15 corresponds to the master process 210 and the storage corresponds to the graph information storage unit 240.

First, to describe a basic operation of processing concerning normal vertices of the input data arrangement process S1101, an operation example when one vertex is allocated to the worker process 1 and the vertex is a normal vertex is shown in FIG. 14. First, the master process transmits a read request 1401 of graph information to the worker process 1. The worker process 1 having received the request is put into a reading state 1402 of the vertex 1, transmits a connected vertex number information data request 1403 of the vertex 1 to the storage, acquires connected vertex number information 1404 of the vertex 1 from the storage, and makes a determination whether the vertex 1 is a normal vertex or a hub vertex to obtain a determination result that the vertex 1 is a normal vertex. Thereafter, the worker process 1 transmits a connection destination vertex information data request 1405 to the storage and acquires connection destination vertex information 1406. The worker process 1 is put into a read complete state 1407 and transmits a process completion notification 1408 to the master process to complete the arrangement process.

First, to describe a basic operation of processing concerning hub vertices of the input data arrangement process S1101, an operation example when one vertex is allocated to the worker process 1 and the vertex is a hub vertex is shown in FIG. 15. First, the master process transmits the read request 1401 of graph information to the worker process 1. The worker process 1 having received the request is put into the reading state 1402 of the vertex 1, transmits the connected vertex number information data request 1403 of the vertex 1 to the storage, and acquires the connected vertex number information 1404 of the vertex 1 from the storage. The worker process 1 makes a determination whether the vertex 1 is a normal vertex or a hub vertex and obtains a determination result that the vertex 1 is a hub vertex because the number of connected vertices of the vertex 1 is larger than the predetermined threshold. The worker process 1 transmits a hub vertex notification 1505 notifying the master process that the vertex 1 is a hub vertex.

The master process having received the hub vertex notification 1505 makes an allocation destination determination 1506 that determines the allocation destination of partial edge information of the vertex 1 as a hub vertex. The allocation destinations determined by the allocation destination determination 1506 are assumed to be the worker process 1 and the worker process 2. The master process transmits a read request 1507 of information of partial edges 1 of the vertex 1 to the worker process 1 and the read request 1507 of information of partial edges 2 of the vertex 1 to the worker process 2. The worker process 1 and the worker process 2 are put into a partial edge 1 reading state 1508-1 and a partial edge 2 reading state 1508-2 and transmit a data request 1509 to the storage to acquire information of the partial edges 1 and information of the partial edges 2 respectively. The worker process 1 and the worker process 2 are put into a partial edge 1 read complete state 1511-1 and a partial edge 2 read complete state 1511-2 and transmit a partial edge read completion notification 1512 to the master process and the master process having received the notification transmits partial edge allocation destination information 1513 to the worker process 1 holding vertex information of the vertex 1. The worker process 1 having received the partial edge allocation destination information 1513 is put into the read complete state 1407 and transmits the process completion notification 1408 to the master process to complete the arrangement process.

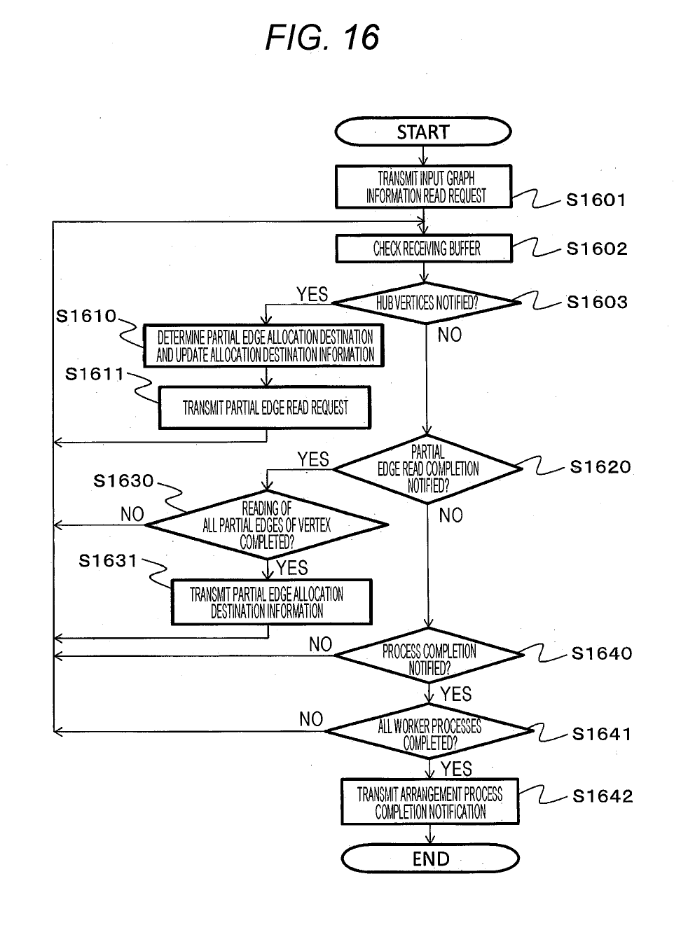

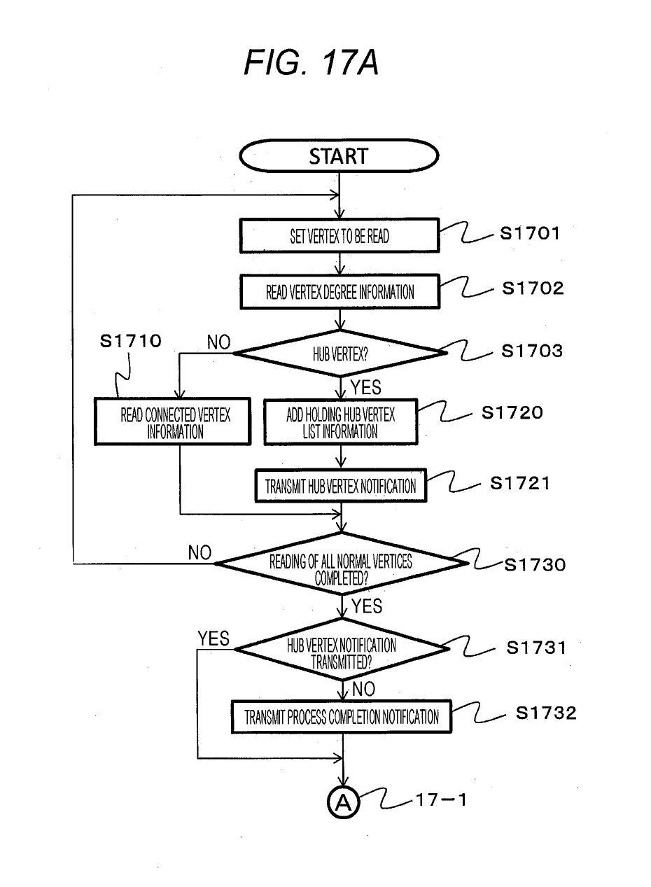

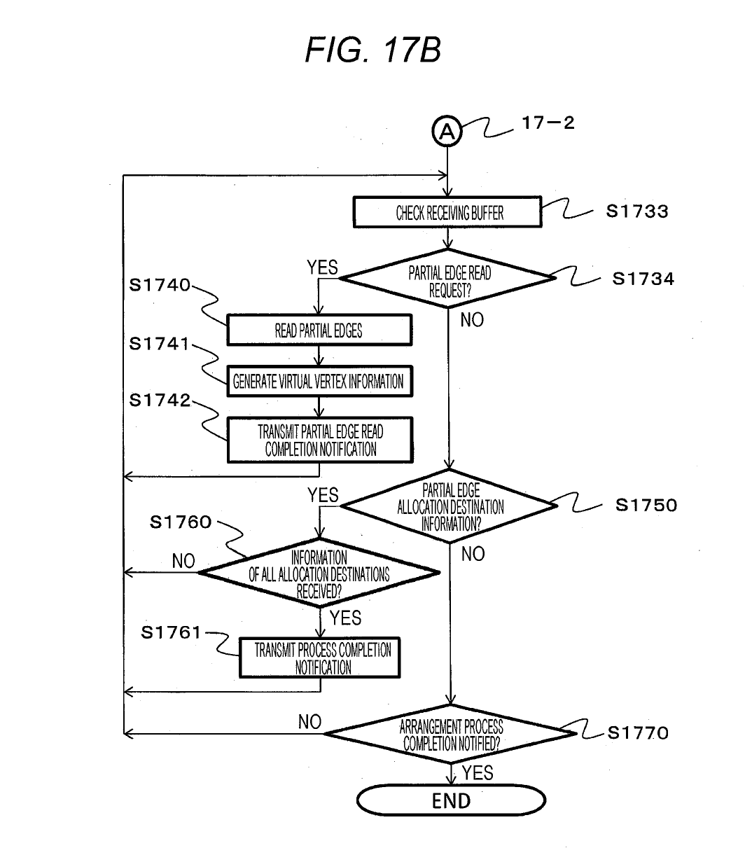

Hereinafter, the operation of the master process 210 and the worker process 220 in the input data arrangement process S1101 will be described in more detail using FIGS. 16, 17A, and 17B.

FIG. 16 is a flow chart showing the operation of the master process 210 in the input data arrangement process S1101. Hereinafter, each processing step in the present flow chart will be described in detail.

First, in step S1601, the master process 210 transmits the read request 1401 of graph information to each of the worker processes 220. The read request 1401 of graph information contains the hub vertex threshold information 211 and information enabling the worker process 220 to identify vertex information read from the graph information storage unit 240. In the present embodiment, the worker process 220 can identify vertex information read from the graph information storage unit 240 based on the global vertex ID 1301.

The master process 210 checks the receiving buffer in step S1602 until some kind of information is received and when received, in step S1603, determines whether the received information is the hub vertex notification 1505. If the received information is the hub vertex notification 1505, the master process proceeds to step S1610 and otherwise, the master process proceeds to step S1620. In step S1610, the master process 210 determines the allocation destinations of the notified hub vertex through the hub partial edge allocation destination determination unit 214 and updates the hub partial edge allocation destination information 212 and the worker process virtual vertex holding status information 213 before proceeding to step S1611.

For example, the hub partial edge allocation destination determination unit 214 refers to the worker process virtual vertex holding status information 213 to preferentially allocate partial edges to the worker process 220 holding the smallest number of virtual vertices. Also, a method of determining the worker process based on the value of the hub vertex threshold information 211 (here, a predetermined degree value Dₕ) such as limiting the number of partial edges allocated to one worker process to, for example, the value of the hub vertex threshold information 211 can be adopted. Because the hub vertex notification 1505 contains degree information (connected vertex number information 410) of the notified vertex, the master process 210 can calculate a number N_{w} of worker processes to which partial edges are allocated according to Formula (1) or the like. N_{w} is a positive integer obtained by rounding up a fractional portion.

N_{w}=(degree information of the notified vertex)/(predetermined degree value Dₕ) (1)

In step S1611, the master process 210 transmits the read request 1507 of partial edges to the allocation destination worker process determined in step S1610 before returning to step S1602.

In step S1620, the master process 210 determines whether the received information is the partial edge read completion notification 1512. If the received information is the partial edge read completion notification 1512, the master process proceeds to step S1630 and otherwise, the master process proceeds to step S1640. In step S1630, if the partial edge read completion notification 1512 determined in step S1620 is the last partial edge read completion notification 1512 about some hub vertex, for example, if, when partial edges of some hub vertex are allocated to the three worker processes 220, the third partial edge read completion notification is received, the master process 210 proceeds to step S1631 to transmit the notification transmits the partial edge allocation destination information 1513 to the worker process 220 having vertex information of the hub vertex before returning to step S1602. If the partial edge read completion notification 1512 is not the last one, the master process 210 directly returns to step S1602.

In step S1640, the master process 210 determines whether the received information is the process completion notification 1408 and if the received information is the process completion notification 1408, proceeds to step S1641 and otherwise, processes the received information appropriately before returning to step S1602. In step S1641, the master process 210 determines whether the process completion notification 1408 determined in step S1640 is the last process completion notification 1408 in the input data arrangement process S1101 and if the process completion notification is the last one, proceeds to step S1642 and otherwise, returns to step S1602. The determination processing in step S1641 is enabled by causing a memory space provided to the master process 210 to store information of the number of the worker processes 220 in the parallel computer system 10 and causing the master process 210 to count the number of the process completion notifications 1408 received from the worker processes 220. In step S1642, the master process 210 transmits an arrangement process completion notification notifying that the input data arrangement process S1101 is completed to all the worker processes 220.

The above is the operation of the master process 210 in the input data arrangement process S1101 of the parallel computer system 10 according to the present embodiment.

Next, the operation of the worker process 220 in the input data arrangement process S1101 of the parallel computer system 10 according to the present embodiment will be described in detail using the flow chart in FIGS. 17A and 17B. A connector A17-1 in FIG. 17A indicates to be connected to a connector A17-2 shown in FIG. 17B.

After receiving the read request 1401 of graph information from the master process 210, the worker process 220 proceeds to step S1701. In step S1701, the worker process 220 having received the read request 1401 of graph information sets the vertex to be read before proceeding to step S1702. In step S1702, the worker process 220 performs processing to read degree information (connected vertex number information 410) of the vertex to be read from the graph information storage unit 240 before proceeding to step S1703. In step S1703, the worker process 220 determines whether the target vertex is a hub vertex by using the read degree information and the hub vertex threshold information 211 obtained from the read request 1401 of graph information and if the target vertex is a hub vertex, proceeds to step S1720 and otherwise, proceeds to step S1710.

In step S1710, the worker process 220 performs processing to read the connection destination vertex information 430 of the vertex to be read from the graph information storage unit 240 before proceeding to step S1730. In step S1720, the worker process 220 performs processing to add the vertex ID of the hub vertex determined in step S1703 to the holding hub vertex list information 224 before proceeding to step S1721. In step S1721, the worker process 220 performs processing to transmit the hub vertex notification 1505 containing the global vertex ID 1301 of the determined hub vertex and the connected vertex number information 410 thereof to the master process 210 before proceeding to step S1730.

In step S1730, the worker process 220 determines whether processing up to step S1730 is completed for all vertices to be read allocated by the read request 1401 of graph information and if completed, proceeds to step S1731 and otherwise, returns to step S1701. In step S1731, the worker process 220 determines whether the hub vertex notification 1505 has been transmitted even once in the input data arrangement process S1101 and if transmitted, proceeds to step S1733 and otherwise, proceeds to step S1732 shown in FIG. 17A. In step S1732, the worker process 220 transmits the process completion notification 1408 to the master process 210 before proceeding to step S1733.

In step S1733, the worker process 220 checks the receiving buffer until some kind of information is received and when received, proceeds to step S1734. In step S1734, the worker process 220 determines whether the information received in step S1733 is the read request 1507 of partial edges and if the information is the read request 1507 of partial edges, proceeds to step S1740 and otherwise, proceeds to step S1750. In step S1740, the worker process 220 performs processing to read a portion of the connection destination vertex information 430 (this will be called partial edge information) of the vertex specified by the read request 1507 of partial edges from the graph information storage unit 240 before proceeding to step S1741. Information indicating a read interval of the partial edge information is, for example, an element number showing an interval (a starting point and an endpoint) to be read from the connection destination vertex ID information array 431 and is contained in the read request 1507 of partial edges. In step S1741, the worker process 220 generates the virtual vertex information 223 to manage the partial edge information read in step S1740 as the part connection destination vertex information 520 and updates the virtual vertex ID conversion table 225. In step S1742, the worker process 220 transmits the partial edge read completion notification 1512 to notify the master process 210 that reading of the partial edge information corresponding to the read request 1507 of partial edges determined in step S1734 before returning to step S1733.

In step S1750, the worker process 220 determines whether the information received in step S1733 is the partial edge allocation destination information 1513 and if the information is the partial edge allocation destination information 1513, proceeds to step S1760 and otherwise, proceeds to step S1770. In step S1760, the worker process 220 determines whether the partial edge allocation destination information 1513 corresponding to all hub vertices of which the master process 210 is notified has been received in the input data arrangement process S1101 and if all the partial edge allocation destination information has been received, proceeds to step S1761 and otherwise, proceeds to step S1733. The determination whether the worker process 220 has received the partial edge allocation destination information 1513 corresponding to all hub vertices of which the master process 210 is notified can be made by comparing the number of times of transmission of the hub vertex notification 1505 transmitted to the master process 210 from the worker process 220 and the number of times of reception of the partial edge allocation destination information 1513 received by the worker process 220 from the master process 210. In step S1761, the worker process 220 transmits the process completion notification 1408 to the master process 210.

In step S1770, the worker process 220 determines whether the information received in step S1733 is an arrangement process completion notification and if the information is an arrangement process completion notification, completes the input data arrangement process S1101 and otherwise, processes the received information appropriately before returning to step S1733.

The above is the operation of the worker process 220 in the input data arrangement process S1101 of the parallel computer system 10 according to the present embodiment. With the operation of the master process 210 and the worker process 220 in the input data arrangement process S1101 described above, the input data arrangement process of the parallel computer system 10 shown in FIG. 12 can be performed.

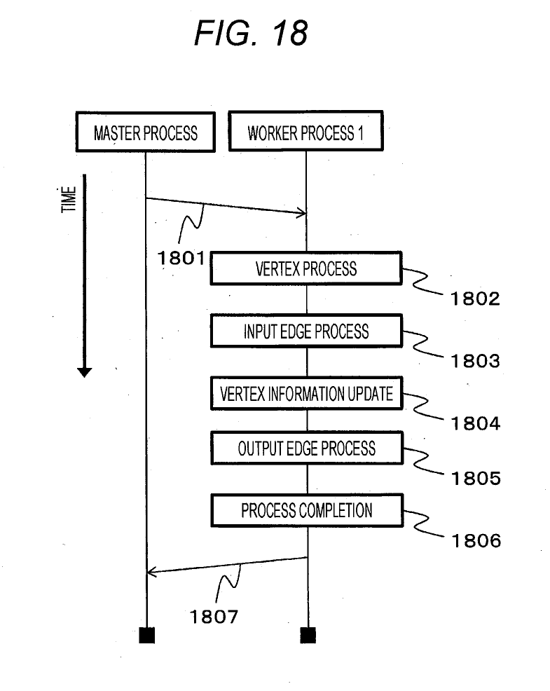

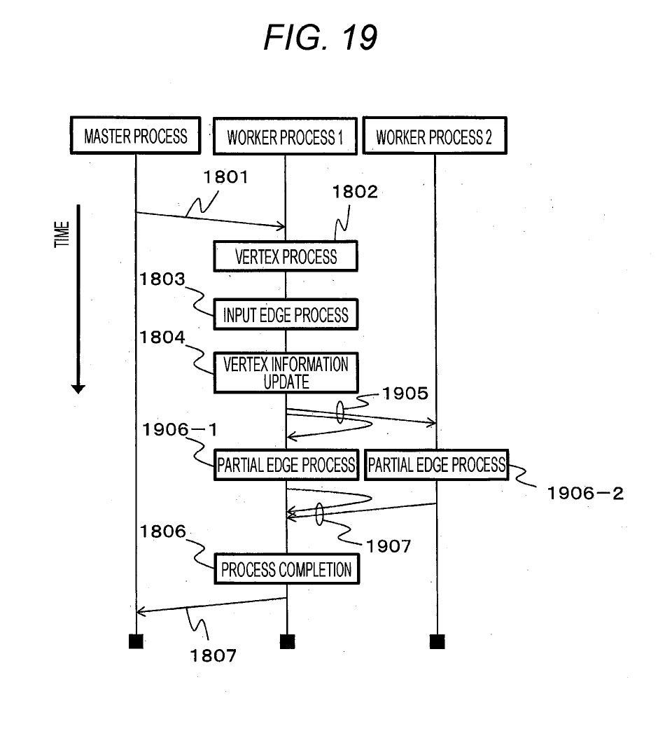

Next, a simple operation example of the master process 210 and the worker process 220 in the graph calculation process S1102 of the parallel computer system 10 will be used using FIGS. 18 and 19. To simplify the description, only two worker processes, the worker process 1 and the worker process 2 are used as the worker process 220 for the description that follows. The master process in FIGS. 18 and 19 corresponds to the master process 210.

An operation example of the graph calculation process S1102 when only normal vertices are allocated to the worker process 1 to describe the basic operation of processing on normal vertices is shown in FIG. 18. First, the master process transmits a calculation process start request 1801 to the worker process 1. The worker process 1 having received the calculation process start request 1801 is put into a vertex processing state 1802 and performs an input edge process 1803 on all vertices held by the worker process through the input edge processing unit 227 and a vertex information update 1804 through the vertex information update unit 228. Because vertices to be processed are normal vertices, an output edge process 1805 is performed by the output edge processing unit 229. Then, the worker process 1 is put into a process complete state 1806 and transmits a process completion notification 1807 to the master process.

Next, an operation example of the graph calculation process S1102 when only hub vertices are allocated to the worker process 1 to describe the basic operation of processing on hub vertices is shown in FIG. 19. First, the master process transmits the calculation process start request 1801 to the worker process 1. The worker process 1 having received the calculation process start request 1801 is put into a vertex processing state 1802 and performs an input edge process 1803 on all vertices held by the worker process through the input edge processing unit 227 and a vertex information update 1804 through the vertex information update unit 228. Because vertices to be processed are hub vertices, the worker process 1 refers to the edge allocation destination information 460 and transmits a partial edge processing request 1905 to the worker process 1 and the worker process 2. The edge allocation destination information 460 is arranged in a memory space provided to the worker process 1 and thus, when compared with a case of arrangement in other worker processes, there is no load on a network when referred to and correspondingly graph processing can be made faster.

The worker process 1 and the worker process 2 having received the partial edge processing request 1905 perform a partial edge process 1906-1 and a partial edge process 1906-2 as an output edge process on partial edges of a hub vertex through the partial edge processing unit 230 respectively and transmit a partial edge process completion notification 1907 to the worker process 1. The worker process 1 having received the partial edge process completion notification 1907 is put into the process complete state 1806 and transmits the process completion notification 1807 to the master process.

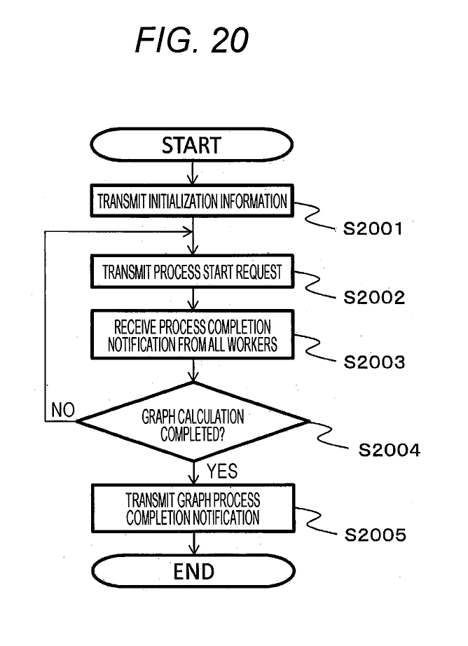

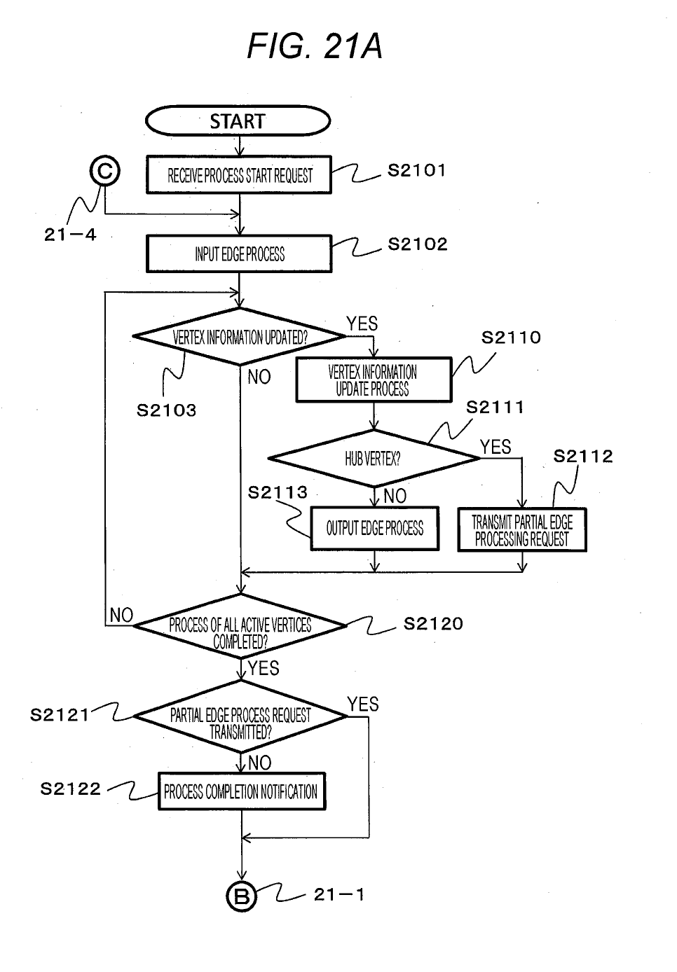

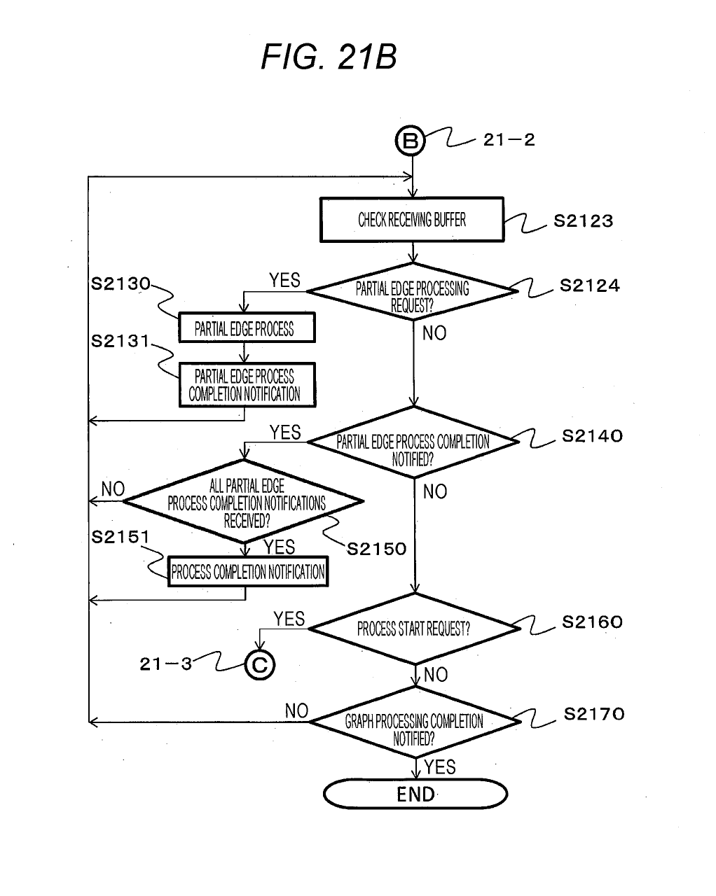

Hereinafter, the operation of the master process 210 and the worker process 220 in the graph calculation process S1102 will be described in more detail using FIGS. 20, 21A, and 21B.

FIG. 20 is a flow chart showing an operation example of the master process 210 in the graph calculation process S1102. Hereinafter, each processing step in the present flow chart will be described in detail. First, in step S2001, the master process 210 transmits to each of the worker processes 220 information (program) of processing content performed for each vertex including the input edge processing unit 227, the vertex information update unit 228, and the output edge processing unit 229 and information to make preparations needed for the graph calculation process such as a request to have the vertex status information 420 created in a memory space of each of the worker processes 220 as initialization information. The initialization information also contains in, for example, the shortest path search problem from the vertex S (starting point) to the vertex T (endpoint), information to activate the vertex S as the starting point.

In step S2002, the master process 210 transmits the calculation process start request 1801 to each of the worker processes 220 before proceeding to step S2003. In step S2003, the master process 210 waits until the process completion notification 1807 is received from all the worker processes 220. In step S2004, the master process 210 determines whether the graph calculation process is completed and if completed, proceeds to step S2005 and otherwise, proceeds to step S2002. As a method of determining whether the graph calculation process is completed, for example, a method in which the master process 210 counts the number of edges processed in the output edge process 1805 immediately before by all the worker processes 220 and determines that the graph calculation process is completed if the value thereof is zero is available and this determination method can be realized by information of the number of edges processed in the output edge process 1805 immediately before by the worker process 220 being contained in the process completion notification 1807 and transmitted.

In step S2005, the master process 210 transmits a graph process completion notification notifying that the graph calculation process S1102 is completed to each of the worker processes 220.

The above is an operation example of the master process 210 in the graph calculation process S1102 of the parallel computer system 10.

Next, the operation of the worker process 220 in the graph calculation process S1102 of the parallel computer system 10 will be described in detail using the flow chart in FIGS. 21A and 21B. A connector B21-1 and a connector C21-4 in FIG. 21A indicate to be connected to a connector B21-2 and a connector C21-3 shown in FIG. 21B.

The worker process 220 receives initialization information from the master process 210 and makes preparations needed for the graph calculation process such as such as creating the vertex status information 420 in the local memory space before proceeding to step S2101. In step S2101, the worker process 220 waits until the process start request 1801 is received from the master process 210.

In step S2102, the worker process 220 checks the receiving buffer in the local memory space and performs an input edge process on a vertex that becomes active (can also be expressed as a vertex accessed from another vertex or a visited vertex) through the input edge processing unit 227. In step S2103, the worker process 220 determines whether to update the vertex status information 420 for the vertex on which the input edge process is performed in step S2102 and if updated, proceeds to step S2110 and otherwise, proceeds to step S2120. As an example in which the vertex status information 420 of the vertex on which the input edge process has been performed is not updated, a case when, for example, in the shortest path search problem without weighted edges, the relevant vertex is a visited vertex can be cited.

In step S2110, the worker process 220 updates the vertex status information 420 before proceeding to step S2111. Step S2103 and step S2110 are performed by the vertex information update unit 228. In step S2111, the worker process 220 determines whether the vertex to be processed is a hub vertex based on the hub vertex threshold information 211 through the hub vertex identification unit 226 and if the vertex is a hub vertex, proceeds to step S2112 and otherwise, proceeds to step S2113. In step S2112, the worker process 220 refers to the edge allocation destination information 460 of the vertex to be processed and transmits the partial edge processing request 1905 to all the worker processes 220 holding partial edges of the vertex to be processed.

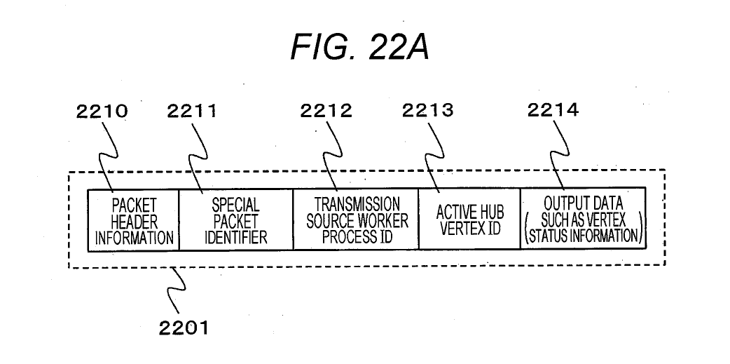

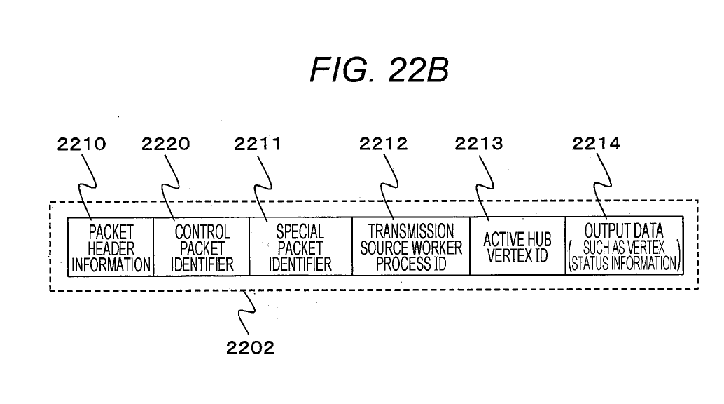

As an example of a packet structure of the partial edge processing request 1905, a packet structure 2201 is shown in FIG. 22A. The packet structure 2201 includes packet header information 2210, a special packet identifier 2211, a transmission source worker process ID 2212, an active hub vertex ID 2213, and output data 2214.

The packet header information 2210 is packet header information satisfying a communication protocol to communicate over the network 250 and contains destination address information and the like. The special packet identifier 2211 is information to allow the worker process 220 on the receiving side to recognize that the relevant packet data is the partial edge processing request 1905 and the present information may be contained in the packet header information 2210. The transmission source worker process ID 2212 is information that makes the worker process 220 of a transmission source determinable. The active hub vertex ID 2213 is information that enables the worker process 220 on the receiving side to recognize a hub vertex (can also be expressed as a virtual vertex) intended for a partial edge process. The output data 2214 is data as a source of information transmitted to connection destination vertices in the output edge process (partial edge process) of partial edges and, for example, the shortest path information corresponds to this data in the shortest path search problem. When, like the present embodiment, the worker process ID of the worker process as an arrangement destination of vertex information of the relevant vertex can be determined from the vertex ID information (global vertex ID information), the transmission source worker process ID 2212 is not necessary.

A modification of the packet structure 2201 is shown in FIG. 22B as a packet structure 2202. The packet structure 2202 is created by adding a control packet identifier 2220 to the packet structure 2201. In the graph processing method according to the present embodiment, information for the next input edge process output to connection destination vertices by the output edge process in step S2113 or the partial edge process in step S2130 and control information to be executed immediately such as the partial edge processing request 1905 are communicated in a mixed form between step S2102 and step S2170 and the number of pieces of communication (can simply be expressed as traffic) caused for information for the next input edge process of the former is disproportionately larger than the number of pieces of communication caused for control information to be executed immediately of the latter. Thus, it becomes necessary to search an increasing amount of received data for a small number of pieces of control information with an increasing scale of graph processing and so the search time of control information can adversely affect the overall processing speed.

Thus, in the case of the modification using the packet structure 2202 as a packet structure of the partial edge processing request 1905, the worker process 220 holds two or more receiving buffers in the memory space managed by the worker process to store information for the next input edge process and control information to be executed immediately in separate receiving buffers. Accordingly, information for the next input edge process can be prevented from affecting the search for control information to be executed immediately and the processing can thereby be shortened. The control packet identifier 2220 is information to determine whether the received packet contains control information to be executed immediately and is used to determine the sorting destination of two or more prepared receiving buffers. The process to determine the sorting destination of two or more prepared receiving buffers can be performed by the communication unit 1013 of the calculation node 1010 on the receiving side.

In step S2113, the worker process 220 performs the output edge process on the vertex to be processed through the output edge processing unit 229. In step S2120, the worker process 220 determines whether the process up to S2120 is completed for all active vertices (all vertices to be processed in the latest input edge process S2102) and if completed, proceeds to step S2121 and otherwise, returns to step S2103.

In step S2121, the worker process 220 determines whether the partial edge processing request 1905 is transmitted even once (whether step S2112 is passed) in the process at the present search level (process from the reception of the latest calculation process start request 1801 up to step S2121) and if transmitted, proceeds to step S2123 and otherwise, proceeds to step S2122. In step S2122, the worker process 220 transmits the process completion notification 1807 to the master process 210. In step S2123, the worker process 220 acquires received information inside the receiving buffer.

In step S2124, the worker process 220 determines whether the information acquired in step S2123 is the partial edge processing request 1905 and if the information is the partial edge processing request 1905, proceeds to step S2130 and otherwise, proceeds to step S2140. Whether the acquired information is the partial edge processing request 1905 can be determined by referring to the special packet identifier 2211.

In step S2130, the worker process 220 performs the output edge process concerning partial edges of the hub vertex specified by the partial edge processing unit 230 through the active hub vertex ID 2213 of the partial edge processing request 1905 (can also be expressed as edges of a virtual vertex held by the relevant worker process). Data transmitted to connection destination vertices in the present output edge process is generated based on the output data 2214. In step S2131, the worker process 220 notifies that the requested partial edge process is completed by transmitting the partial edge process completion notification 1907 to the worker process 220 indicated by the transmission source worker process ID 2212 before returning to step S2123.

In step S2140, the worker process 220 determines whether the information acquired in step S2123 is the partial edge process completion notification 1907 and if the information is the partial edge process completion notification 1907, proceeds to step S2150 and otherwise, proceeds to step S2160. In step S2150, the worker process 220 determines whether all the partial edge process completion notifications 1907 have been received and if received, proceeds to step S2151 and otherwise, proceeds to step S2123. Whether all the partial edge process completion notifications 1907 have been received can be determined by, for example, checking whether the number of times of transmitting the partial edge processing request 1905 by the worker process 220 and the number of times of receiving the partial edge process completion notification 1907 are equal. In step S2151, the worker process 220 transmits the process completion notification 1807 to the master process 210 before returning to step S2123.

In step S2160, the worker process 220 determines whether the information acquired in step S2123 is the calculation process start request 1801 and if the information is the calculation process start request 1801, proceeds to step S2102 and otherwise, proceeds to step S2170. In step S2170, the worker process 220 determines whether the information acquired in step S2123 is a graph processing completion notification and if the information is a graph processing completion notification, terminates the graph calculation process S1102 and otherwise, proceeds to step S2123. The above is an operation example of the worker process 220 in the graph calculation process S1102.

As described above, the parallel computer system 10 can realize excellent parallel processing scalability even in a graphical analysis process with a scale-free characteristic by arranging edge information of a hub vertex in a memory space of a process other than the process in which the information about the hub vertex is arranged. In addition, a solution according to the present invention can also be applied to existing programming models based on the BSP model and the like and therefore, a programmer as a user of the present system can describe program code of graphical analysis easily without being aware of complex internal operations of the parallel computer system 10.

What is claimed is:

1. A graph processing method of a parallel computer system that performs a plurality of processes to each of which a memory space is allocated, the graph processing method comprising:
arranging information of graph vertices in a first memory space allocated to a first process; and
arranging edge information of the graph vertices in a second memory space allocated to a second process.

2. The graph processing method according to claim 1, wherein
when the graph vertex is intended for an output edge process, the first process transmits a packet notifying that the graph vertex is intended for the output edge process to the second process.

3. The graph processing method according to claim 2, wherein
when the packet is received, the second process performs an edge process based on the edge information, and
notifies the first process of completion of the edge process.

4. The graph processing method according to claim 1, wherein
when the edge information is arranged, the edge information is arranged based on information of a degree of the graph vertex.

5. The graph processing method according to claim 1, wherein
when the edge information is arranged, the edge information of the graph vertex is arranged in the second memory space if a degree of the graph vertex is larger than a predetermined value.

6. The graph processing method according to claim 1, wherein
information about an arrangement of the edge information is stored in the first memory space.

7. The graph processing method according to claim 1, wherein
the graph vertex is a hub vertex.

8. An information processing system that performs a plurality of processes to each of which a memory space is allocated, wherein
graph structure data stored in a storage is read,
information of graph vertices in the graph structure data is arranged in a first memory space allocated to a first space,
edge information of the graph vertices is arranged in a second memory space allocated to a second process, and
graph processing on the graph structure data is performed.

9. The information processing system according to claim 8, wherein
when the graph vertex is intended for an output edge process, the first process transmits a packet notifying that the graph vertex is intended for the output edge process to the second process.

10. The information processing system according to claim 9, wherein
when the packet is received, the second process performs an edge process based on the edge information, and
notifies the first process of completion of the edge process.

11. The information processing system according to claim 8, wherein
when the edge information is arranged, the edge information is arranged based on information of a degree of the graph vertex.

12. The information processing system according to claim 8, wherein
when the edge information is arranged, the edge information of the graph vertex is arranged in the second memory space if a degree of the graph vertex is larger than a predetermined value.

13. The information processing system according to claim 8, wherein
information about an arrangement of the edge information is stored in the first memory space.

14. The information processing system according to claim 8, comprising:
a first calculation node;
a second calculation node; and
a network device that connects the first calculation node and the second calculation node, wherein
the first process is performed in the first calculation node, and
the second process is performed in the second calculation node.

15. The information processing system according to claim 8, comprising:
an information processing apparatus including a first CPU and a second CPU, wherein
the first process is performed by the first CPU, and
the second process is performed by the second CPU.
